(19) United States
(12) Patent Application Publication
(10) Pub. No.: US 2015/0159402 A1
(43) Pub. Date: Jun. 11, 2015

(54) SELF-CONTAINED ELECTRONIC CYLINDER LOCK ALTERNATIVELY OPERABLE BY A KEY

(71) Applicant: Itai Yahav, New York, NY (US)

(72) Inventor: Itai Yahav, New York, NY (US)

(21) Appl. No.: 14/563,465

(22) Filed: Dec. 8, 2014

Related U.S. Application Data
(60) Provisional application No. 61/912,758, filed on Dec. 6, 2013.

(51) Int. Cl. E05B 63/08

(52) U.S. Cl. CPC E05B 63/08

(57) ABSTRACT

An electronic lock is provided that can be installed in an existing installation and includes a locking cylinder and an electronic device operated by a user to release the locking cylinder. A mortise cylinder operable by a key is also provided to release the same locking cylinder. In preferred form, the locking cylinder is unlocked by actuation of a battery driven drive motor engaging a gear serving as a pawl. The battery driven drive motor is actuated by operation of a key pad or other electronic coding, or by the key activating a switch for the motor.

### CROSS REFERENCE TO RELATED APPLICATION

This application is based on provisional application Ser. No. 61/912,758 filed Dec. 6, 2013.

### FIELD OF THE INVENTION

The present invention relates to a self contained cylinder lock that can be actuated electronically from a keypad or by a conventional key, and can be installed in existing installations.

### BACKGROUND OF THE INVENTION

Many electronic cylinder locks are known, but typically these digital locks require extensive modification to an existing installation that previously had received a conventional mortise lock for an interior or exterior door, or cabinet or the like; or wiring may need to be added to provide power to enable the lock to be operated electronically. As more and more consumers request an electronic lock for their doors in order to have the benefits of an electronic lock, e.g. never having to worry about losing your keys or having the added bulk of keys to carry, they turn to an electronic lock actuated by such measures as a keypad, voice, face or fingerprint recognition, or a specific actuator as a magnetically coded card. However, such electronic locks often require a costly design reconfiguration of the door and jam.

It is, therefor, an object of the present invention to provide a self-contained electronic lock for a door or the like that can be installed readily in existing installations and yet can be operated electronically by a keypad or the like, as well as by a conventional key. In the present invention, a lock is used that can be installed into an existing door configured for a conventional key and cylinder lock, and the existing structures in the door jam can also be used. It is understood that the lock of the present invention could also be easily adapted to be used in other installations, such as a lock for a cabinet or other door.

### SUMMARY OF THE INVENTION

According to the present invention, a lock is provided that has been configured to be installed in an existing installation and includes a locking cylinder adapted to be installed in an existing door installation and can be rotated to a position unlocking the door, a pawl is adapted to engage the locking cylinder to prevent rotation of the locking cylinder to its unlocked position, and an electronic device operated by a user to release the pawl from its engagement with the locking cylinder, and a mortise cylinder operable by a key to remove the same pawl from the locking cylinder by use of the key. In preferred form, the pawl is removed from its locking position by actuation of a battery driven drive motor engaging a gear serving as the pawl. The battery driven drive motor is actuated by operation of a key pad or other electronic coding, or by the key activating a switch for the motor.

The present invention is illustrated by way of example in the attached drawings and descriptions and includes a cylinder lock actuated by a conventional key or the proper input to a keypad to activate a drive motor responding to the proper input to the keypad, or actuation of the conventional key.

### BRIEF DESCRIPTION OF THE DRAWINGS

The attached figures illustrate a digital cylinder lock according to the present invention with a description of the features and operations.

FIG. 1 illustrates the installation of a lock according to the present invention on an existing door;

FIG. 2 illustrates a lock according to the present invention;

FIG. 3 illustrates the internal features of a lock according to the present invention;

FIG. 3A illustrates details of FIG. 3;

FIG. 4 is a sectional view of the internal features of the lock of FIG. 3;

FIG. 4A illustrates details of FIG. 4;

FIG. 5 is an exploded view of the lock of FIG. 3;

FIG. 6 is a side view of the lock of FIG. 3;

FIG. 7 is a rear view of the lock of FIG. 3.

### DETAILED DESCRIPTION OF AN EMBODIMENT

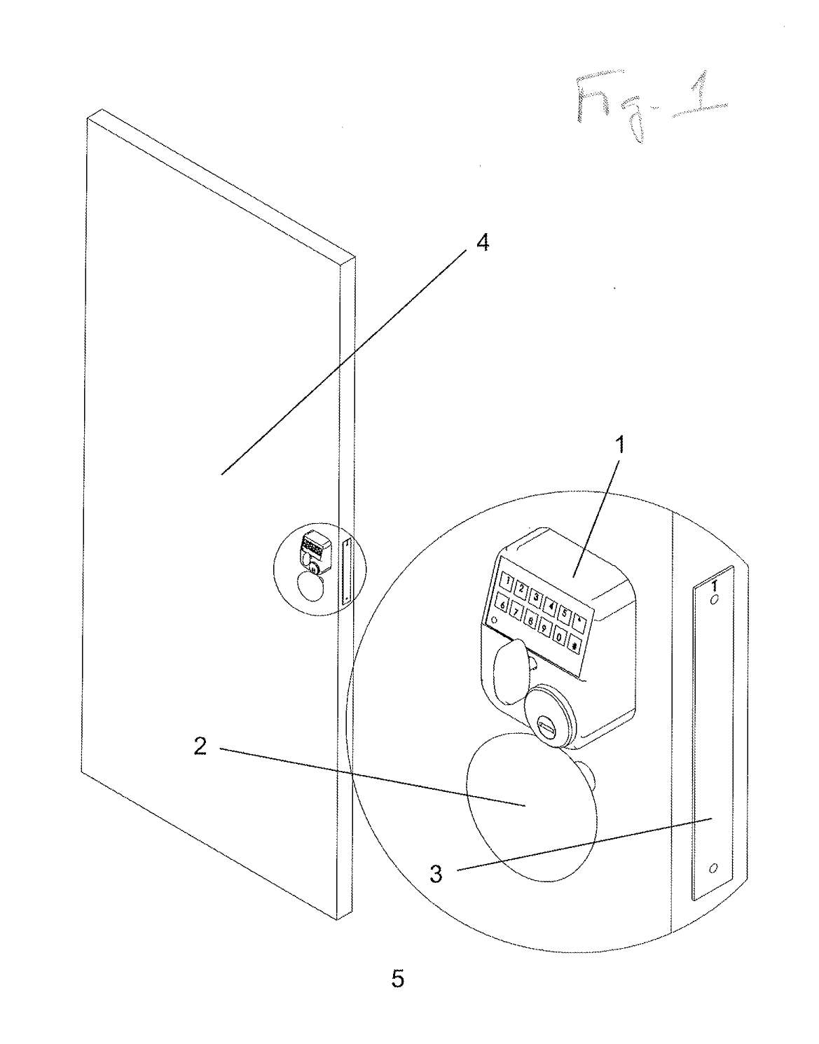

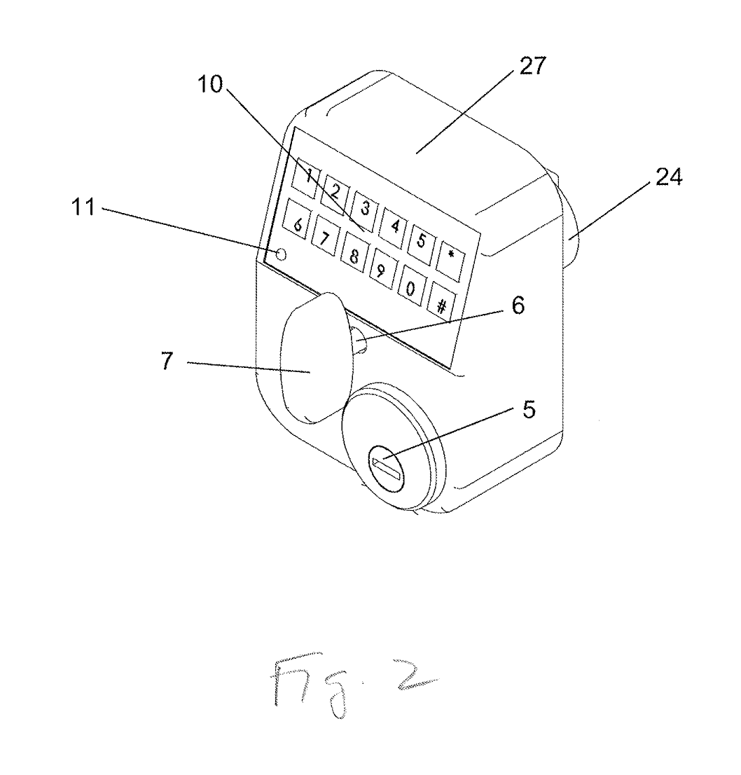

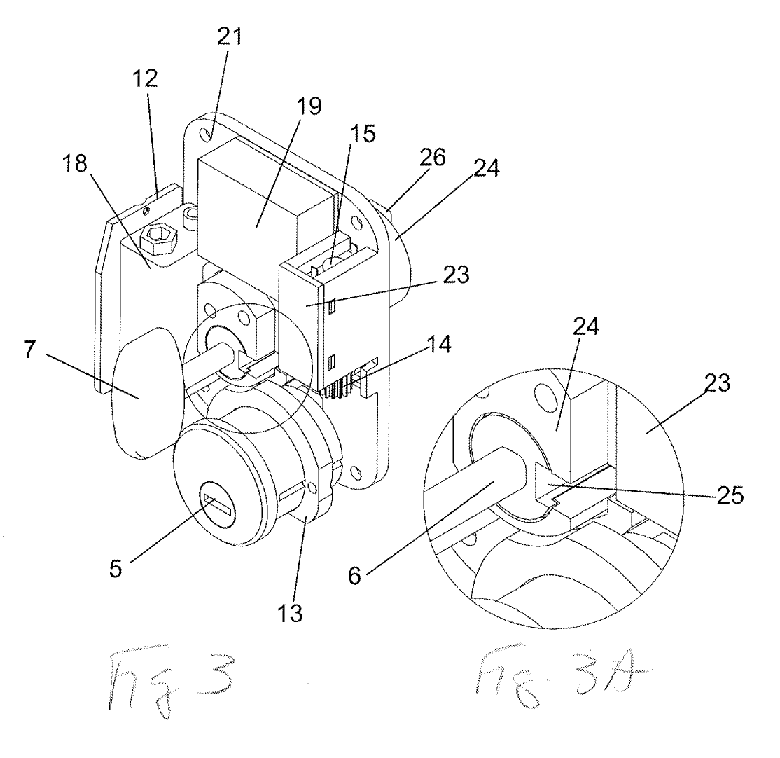

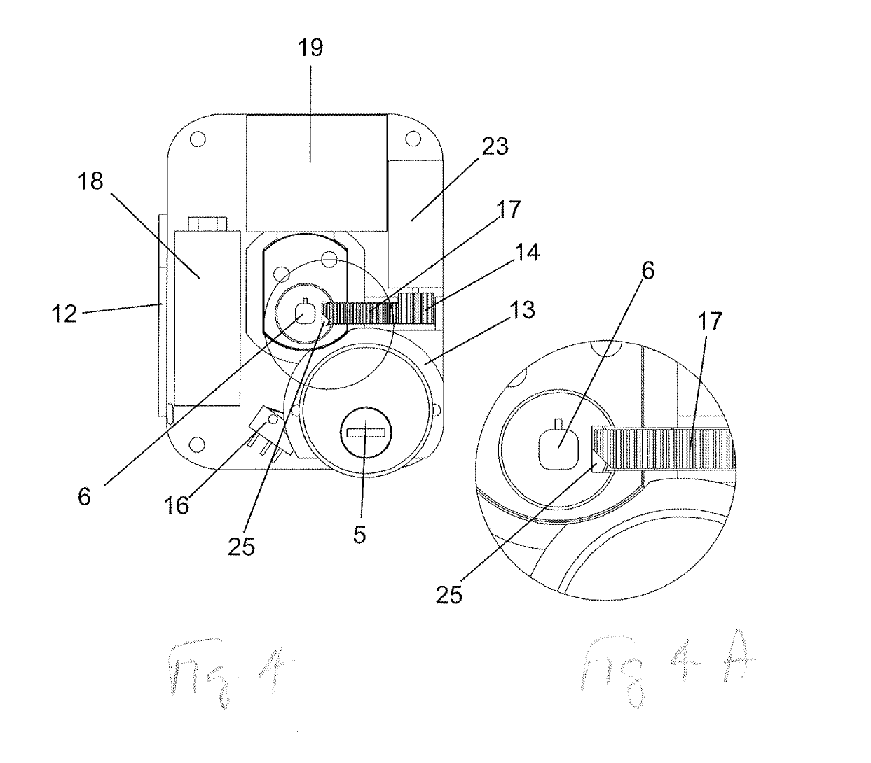

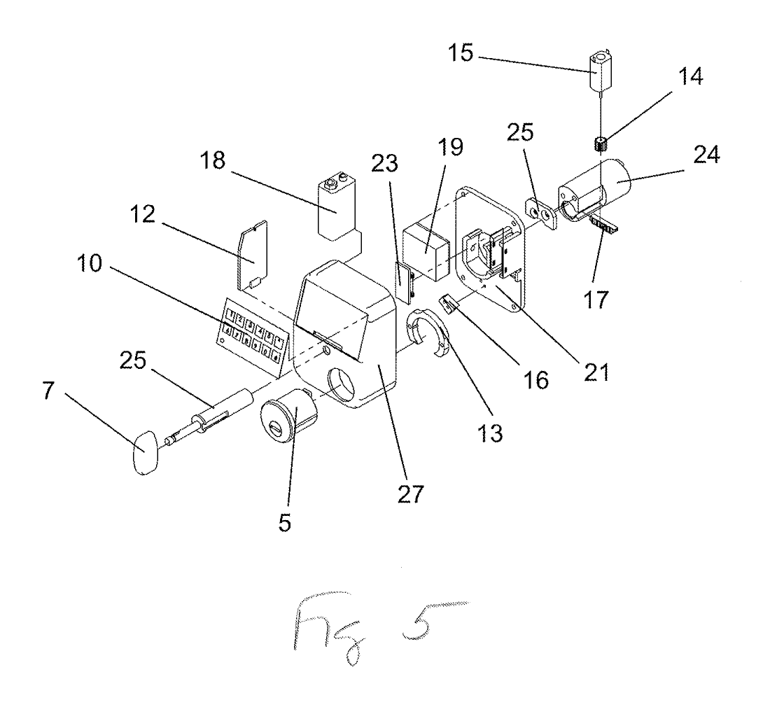

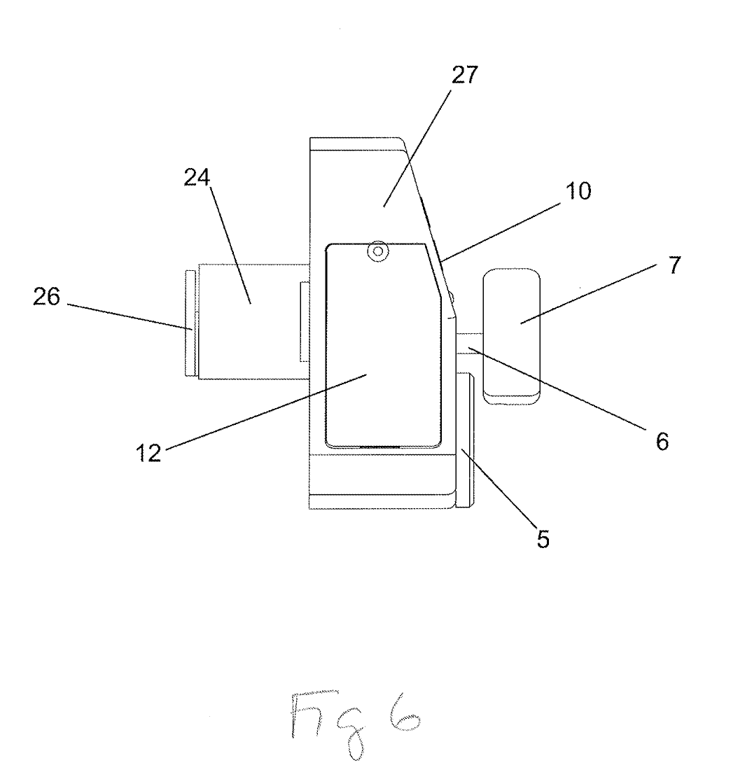

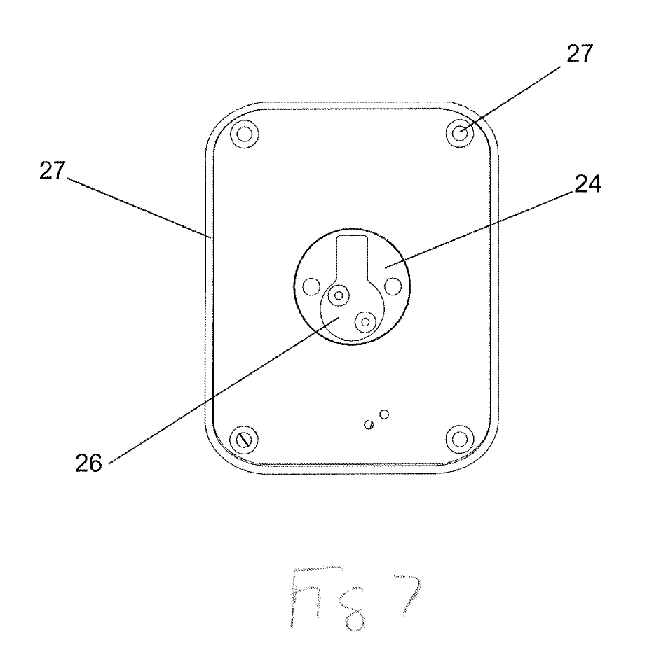

As shown in FIG. 1, the lock 1 of the present invention can be installed in a door 4 adapted to receive a conventional key-operated mortise lock. Plate 3 represents the conventional structures operated by door knob 2 when the door is to be opened. FIG. 2 illustrates a lock according to the present invention, and includes cover 27 containing an electronic keypad 10. As would be understood, other electronic devices for providing a coded signal may be utilized instead of a key pad, such as, voice, face or fingerprint recognition, a specific actuator as a magnetically coded card or the like. Knob 7 connected to shaft 6 engaging the lock cylinder 24 shown in FIG. 4 allows the door to be unlocked when the proper code has been entered in the key pad. LED 11 indicates electronic operation of the lock, and status, such as a green light to indicate the correct code, a red light to show the wrong code, and an orange or yellow light to indicate a low battery.

A mortise cylinder 5 is operable by a conventional key to unlock the lock as will be described below.

The keypad 10 is connected to the control panel 19 to signal the control panel 19 to deliver power from battery 18 to motor 15 within motor housing 23. The shaft of motor 15 to is connected to rotate motor gear 14 upon the control panel 19 receiving the appropriate input signal, to withdraw slide gear 17 serving as a pawl from a restraining notch within lock-cylinder insert 25 of the lock cylinder 24. Shaft 6 is keyed to the lock-cylinder insert 25 and knob 7 may be turned when the slide gear 17 is withdrawn from restraining notch 25 to actuate rear cam 26 to unlock the door.

To override the electronic unlocking system, the mortise cylinder 5 operable by a key is held in place by cylinder ring 13, and when rotated by use of the key actuates micro switch 16 to signal the control panel to activate the motor 15 and release the slide gear 17 from the notch within lock-cylinder insert 25 of the lock cylinder 24.

Housing components 12, 21 and 27 complete the lock assembly. As understood, actuators other than a motor may be utilized with the present invention. For example, a solenoid may be used to withdraw a pawl from a restraining notch in a lock cylinder.

What is claimed is:

1. A lock configured to be installed in an existing installation for a conventional key lock, includes a locking cylinder adapted to be installed in an existing installation and can be rotated to an unlocking position, a pawl adapted to engage the locking cylinder to prevent rotation of the locking cylinder to its unlocked position, an electronic device operated by a user to release the pawl from its engagement with the locking cylinder, and a mortise cylinder operable by a key to remove the same pawl from the locking cylinder by use of the key.

2. A lock as set forth in claim 1, including a battery-driven drive motor engaging a gear swerving as said pawl; said battery driven drive motor being actuated by operation of a key pad or other electronic coding, or by the key to activate a switch for the motor.
